(19) United States
(12) Patent Application Publication
(10) Pub. No.: US 2006/0085448 A1
(43) Pub. Date: Apr. 20, 2006

(54) Program encoding method and system thereof

(75) Inventors: Ming-Hung Hsieh, HsinTien City (TW); Ying-Hung Chou, Hsin-Tien City (TW)

Correspondence Address: SUGHRUE MION, PLLC, 2100 PENNSYLVANIA AVENUE, N.W., SUITE 800, WASHINGTON, DC, 20037, US

(73) Assignee: VIA TECHNOLOGIES, INC.

(21) Appl. No.: 11/004,957

(22) Filed: Dec. 7, 2004

(30) Foreign Application Priority Data
Oct. 20, 2004 (TW) 93131873

(51) Int. Cl. G06F 7/00

(52) U.S. Cl. 707/100

(57) ABSTRACT

According to the method of the present invention, first, the code of the program language used to develop a web page is classified and rearranged. Next, the rearranged program code is transferred to another program code with similar syntax. Then, the transferred code is compiled to generate an object file and a web page program file.

### RELATED APPLICATIONS

The present application is based on, and claims priority from, Taiwan Application Serial Number 93131873, filed on Oct. 20, 2004, the disclosure of which is hereby incorporated by reference herein in its entirety.

### FIELD OF THE INVENTION

The present invention relates to an encoding method, and more particularly, to a program encoding method and system thereof.

### BACKGROUND OF THE INVENTION

The Active Server Page (ASP) is used to deliver any type of dynamic content as well as allow interaction between users and the World Wide Web (WWW). Compared with the hypertext markup language (HTML), the main difference is that ASP is a server language. Typically, the text and tables in a web page created by the HTML language is fixed after the web page is created. In other words, the format and the content of the HTML web page is not changed when delivering it from the server. However, when an ASP file is processed by the ASP parser in the server, the server may create HTML files according to different conditions and send those files to a browser. Because all of the HTML files are processed by the server, the user only receives the processed files, thus reducing the burden on the client's browser and consequently reducing download time.

Most web pages today are written in ASP. After a web page is written by programmers, the core code is encoded to avoid the code being stolen by a criminal before delivering it to a client. However, either the appropriate decoding program must already exist on the market or an additional translating/linking file is required to undo the typical encoding method. Therefore, an encoding method and system that may resolve the foregoing problems is required.

### SUMMARY OF THE INVENTION

The main purpose of the present invention is to provide an encoding method and system thereof that does not require an additional translating/linking object module and instead may be directly performed in the server.

A criminal cannot easily decode an executable object file. Therefore, the encoding method of the present invention is to encode a core code of the web page to an executable object file and a web page program file. Then, the executable object file is called when the web page program file is delivered.

According to the method of the present invention, first, the code of the program language used to develop a web page is classified and rearranged. Next, the rearranged program code is transferred to another program code with similar syntax. Then, the transferred code is compiled to generate an object file and a web page program file.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is an encoding flow chart according to the preferred embodiment of the present invention; and

FIG. 2 is a block diagram for the encoding method according to the preferred embodiment of the present invention.

### DETAILED DESCRIPTION OF THE PREFERRED EMBODIMENT

The encoding method described in the following embodiment refers to the ASP language. However, the present invention may be used in any object-oriented programming language, such as Java Server Pages.

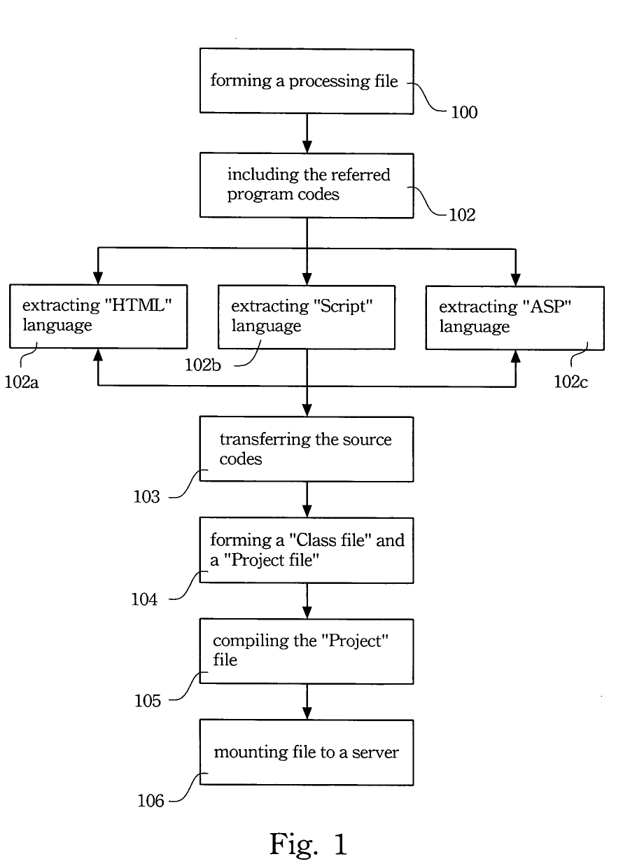

FIG. 1 is an encoding method flow chart of the preferred embodiment of the present invention. First, in step 100, a processing file is formed. The forming method is first to select the source code that needs to be encoded in an ASP file. Then, the selected source code is copied to form this processing file. It is noticed that the encoding method of the present invention permits forming many processing files concurrently.

Next, in step 102, the program code referred in the processing file is included therein. Then, the source code of the processing file is classified according to the language syntax. The purpose is to group the source code referring different program code. For example, in this embodiment, “HTML” source code is extracted into a group 102a. “Script” source code, such as the Java language, is extracted into a group 102b. “ASP” source code is extracted into a group 102c.

It is noticed that the grouping standard is changeable according to the language referred in the processing file. For example, the source code may also be grouped according to a “dynamic” language and a “static” language. Typically, the format and the data shown on a web site are fixed if the “HTML” source code cannot be changed by the server but can only be changed by a programmer. The language forming this web site is a “static” language. In contrast, if the format and the data shown on a web site are changeable, such as for a site selling tickets according to interactive user selection, the language forming this web site is a “dynamic” language. Accordingly, in the step 102, the source code of this processing file is also grouped according to a “dynamic” language and a “static” language.

In step 103, the grouped source code is transferred. In this embodiment, the source code is transferred to object code of a “Visual Basic” programming language. It is noticed that the source code may also be transferred to another programming language code, as long as one skilled in the art thinks the language structure between the object code and the source code is similar. For example, the reason for selecting a “Visual Basic” language as that the “Visual Basic” object code and that of the “ASP” language are very similar.

In step 104, a class file is formed after the source code is transferred according to the “Visual Basic” language. Typically, one processing file generates one class file. Therefore, if many processing files are processed together by this encoding method, many class files are also generated. Afterward, these class files are grouped into a project file.

In step 105, the project file is compiled. In this embodiment, the source code is transferred to “Visual Basic” code. Therefore, the “Visual Basic” language compiler is used to compile the project file so as to form an “executable object file” and a “web page program file”. The executable object file is called when the web page program file is delivered. It is noticed that if the source code is transferred to the object code of another programming language in step 103, the program compiler is used in the compiling step.

From step 100 to step 105, the processing file is compiled and generates two files: an “executable object file” and a “web page program file”. Finally, the “executable object file” and the “web page program file” are mounted onto a server in step 106.

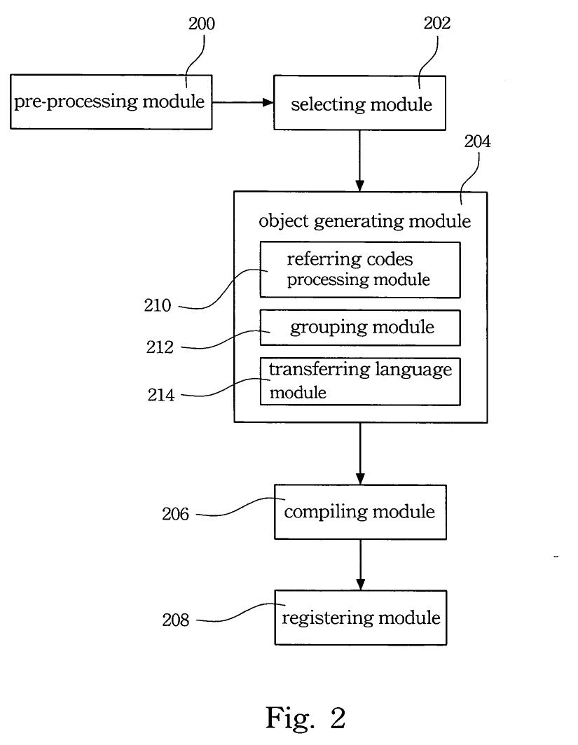

FIG. 2 illustrates a block diagram of a system for performing the encoding method of the present invention. According to the present invention, the system comprises a pre-processing module 200, a selecting module 202, an object-generating module 204, a compiling module 206 and a registering module 208.

The pre-processing module 200 is used to generate a copy of the source code of a file. The selecting module 202 selects the source code to be encoded to form a processing file. The processing file is sent to the object-generating module 204. This object-generating module 204 groups and transfers the processing file to generate a class file.

This object-generating module 204 is composed of a referring code processing module 210, a grouping module 212 and a transferring language module 214. The program code referred in the processing file is included therein by the referring code processing module 210. Then, the source code is sent to the grouping module 212. The grouping module 212 groups the received source code according to the language syntax. The purpose is to group the source codes referring different program code. For example, the source code of the processing file is grouped according to a “dynamic” language and a “static” language. The grouped source code is sent to the transferring language module 214 to transfer the source code according to a specific language. Finally, a class file is generated.

Then, the class file is sent to the compiling module 206 from the transferring language module 214. The class file is compiled in the compiling module 306 to generate an “executable object file” and a “web page program file”. After the processing file is compiled, the compiled file including the “executable object file” and the “web page program file” is loaded onto a server by the registering module 208. It is noticed that the system also may provide a graph interface module for providing a plurality of selection items to a user to operate the encoding program.

Accordingly, the encoding method of the present invention first groups the code of the file for developing a web page. Next, the code is transferred to object code of a programming language that is very similar to the language of the subject file. Then, the transferred code is compiled to generate an object file and a web page program file. Because a criminal has difficulty in decoding an executable object file, the encoding method of the present invention is to encode a core code of a web page to an executable object file and a web page program file. Then, the executable object file is called when the web page program file is delivered.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

What is claimed is:

1. An encoding method for web page source code, comprising:
classifying said source code to a static language source code and a dynamic language source code;
transferring said static language source code and said dynamic language source code to generate a class file according to a corresponding programming language; and
compiling said class file to generate a web page program file and an executable object file to a server.

2. The method of claim 1, before classifying said source code further comprises the step of:
processing program code referred by said source code.

3. The method of claim 1, further comprising:
selecting a part of said source code to classify said selected source code to a static language source code and a dynamic language source code.

4. An encoding system for web page source code, comprising:
an object generating module for classifying and transferring said source code to a class file; and
a compiling module for compiling said class file to generate a web page program file and an executable object file to a server.

5. The system of claim 4, further comprising:
a selecting module for selecting a part of said source code to provide to said object generating module to generate said class file.

6. The system of claim 4, further comprising:
a pre-processing module for generating a copy of said source code, wherein said copy is sent to said encoding system.

7. The system of claim 4, further comprising:
a registering module for registering said web page program file and said executable object file to said server.

8. The system of claim 4, wherein said object generating module further comprises:
a referring codes module for processing the code referred by said source code.

9. The system of claim 4, wherein said object generating module further comprises:
a grouping module for classifying said source code to a static language source code and a dynamic language source code.

10. The system of claim 4, wherein said object generating module further comprises:
a transferring language module for transferring said static language source code and said dynamic language source code to generate a class file according to a corresponding program language.

11. A computer usable medium having stored thereon an encoding program for a web page source code, said encoding program comprising:
an object generating module for classifying and transferring said source code to a class file; and
a compiling module for compiling said class file to generate a web page program file and an executable object file to a server.

12. The medium of claim 11, further comprising:
a selecting module for selecting a part of said source code to provide to said object generating module to generate said class file.

13. The medium of claim 11, further comprising:
a pre-processing module for generating a copy of said source code, wherein said copy is sent to said encoding system.

14. The medium of claim 11, further comprising:
a registering module for registering said web page program file and said executable object file to said server.

15. The medium of claim 11, wherein said object generating module further comprises:
a referring codes module for processing the code referred by said source code.

16. The medium of claim 11, wherein said object generating module further comprises:
a grouping module for classifying said source code to a static language source code and a dynamic language source code.

17. The medium of claim 11, wherein said object generating module further comprises:
a transferring language module for transferring said static language source code and said dynamic language source code to generate a class file according to a corresponding program language.

18. The medium of claim 11, further comprising:
a graph interface module for providing a plurality of selection items to operate said encoding program.
